(19) United States
(12) Patent Application Publication
(10) Pub. No.: US 2026/0014639 A1
(43) Pub. Date: Jan. 15, 2026

(54) TWO-STEP SPOT WELDING PROCESS USING A CONCENTRIC ELECTRODE

(71) Applicant: GM Global Technology Operations LLC, Detroit, MI (US)

(72) Inventors: Zhenke Teng, Troy, MI (US); Ying Lu, Novi, MI (US); Robert W. Watson, China, MI (US); Jason M. Brown, Goodrich, MI (US)

(21) Appl. No.: 18/773,985

(22) Filed: Jul. 16, 2024

(30) Foreign Application Priority Data
Jul. 11, 2024 (CN) 202410928887.4

(51) Int. Cl. B23K 11/30; B23K 11/11

(52) U.S. Cl. CPC B23K 11/3009; B23K 11/115

(57) ABSTRACT

A concentric electrode is provided. The concentric electrode includes a cylindrical base and a tip disposed on the cylindrical base. The cylindrical base extends axially along an axis of rotation, and the cylindrical base includes a conductive metal. The tip includes a concentric surface extending axially from the cylindrical base and defined by an outer shoulder having an outside diameter and an inner shoulder having an inside diameter. The tip is configured to provide an electrical current to a steel workpiece and purge a coating from at least a portion of the steel workpiece.

### INTRODUCTION

The present disclosure relates to a steel workpiece, and more particularly to a steel workpiece including a coating, and a method of spot-welding multiple steel workpieces.

The use of a zinc coating on steel components (commonly referred to as galvanized steel) has been utilized in numerous industries to inhibit corrosion of the steel. One industry that has benefited from the use of zinc coated steel is the automotive industry. The wear and tear of driving and the exposure of vehicles to the elements (e.g., water, oxygen, and chloride-based de-icing agents) leave the steel components of the vehicle susceptible to corrosion if not coated with anti-corrosion agent, such as zinc.

However, a zinc coating is prone to producing an undesirable property during a welding process. More specifically, the zinc liquifies and penetrates into the steel when heated by the electric current of a welding process. The zinc facilitates a phenomenon known in the art as liquid metal embrittlement (LME), in which the steel experiences drastic loss in tensile ductility and/or undergoes brittle fracture due to the penetrating zinc. As such, previous zinc coated steels were susceptible to mechanical failures after welding.

A practical significance of LME is evident in multiple steels such as Gen3 steels which are desirable for use in automobile vehicles to achieve increased material strength and reduced weight. Gen3 steels are defined herein as a steel having a minimum tensile strength (e.g., up to 1500 MPa or more) and an elongation (e.g., 20 percent). Gen3 steels have been observed to experience ductility losses and cracking during welding, and LME cracking may occur catastrophically, and high crack growth rates have been observed. Certain desirable materials such as Zn coated Gen3 which benefit from a corrosion resistant coating have therefore been restricted from use in automobile vehicles.

LME cracking may occur in known zinc and aluminum coating materials during welding operations such as resistance spot welding for joining metal components with the low melting temperature coating materials. LME cracking may occur due to differences in metal melting temperatures and the pressure applied during the resistance welding process, particularly at an intersection between the base material such as a steel material and the coating material. LME cracking weakens the substrate material, reducing the base strength of the substrate material.

While prior art methods and systems attempt to provide coating removal for spot welding and may achieve their particular purpose. However, those offline surface treatment processes are time consuming and costly. A need still exists for a new and improved process for coating removal prior to spot welding.

### SUMMARY

According to several aspects of the present disclosure, a concentric electrode is provided. The concentric electrode includes a cylindrical base and a tip disposed on the cylindrical base. The cylindrical base extends axially along an axis of rotation, and the cylindrical base includes a conductive metal. The tip includes a concentric surface extending axially from the cylindrical base and defined by an outer shoulder having an outside diameter and an inner shoulder having an inside diameter. The tip is configured to provide an electrical current to a steel workpiece and purge a coating from at least a portion of the steel workpiece.

In accordance with another aspect of the disclosure, the concentric electrode includes a tip having a flat concentric surface.

In accordance with another aspect of the disclosure, the concentric electrode includes an outside diameter of about 8 millimeters, and the inside diameter is about 5 millimeters.

In accordance with another aspect of the disclosure, the concentric electrode includes a flat concentric surface having a thickness of about 3 millimeters, and the thickness extends axially from the cylindrical base.

In accordance with another aspect of the disclosure, the concentric electrode includes a flat concentric surface having a ring width between the outside diameter and the inside diameter of about 1.5 millimeters.

In accordance with another aspect of the disclosure, the concentric electrode includes a tip including a rounded concentric surface.

In accordance with another aspect of the disclosure, the concentric electrode includes a steel workpiece including a third-generation advanced high strength steel (AHSS).

In accordance with another aspect of the disclosure, the concentric electrode includes a coating formed of zinc.

In accordance with another aspect of the disclosure, the concentric electrode is coupled to a welding robot.

According to several aspects of the present disclosure, a method of two-step spot welding is provided. The method includes providing a workpiece stackup, contacting a first concentric electrode to the first steel workpiece and contacting a second concentric electrode to the second steel workpiece, purging a coating from the first steel workpiece to form a first local exposed portion and from the second steel workpiece to form a second local exposed portion by passing an electric current between the first concentric electrode and the second concentric electrode and through the workpiece stackup, and spot welding the first steel workpiece and the second steel workpiece using a first welding electrode and a second welding electrode, respectively. The first steel workpiece and the second steel workpiece include a coating. The first concentric electrode and the second concentric electrode each have an outside diameter, an inside diameter, and a tip. The locally exposed portions are shaped in the form of a concentric circle having the outside diameter and the inside diameter and are defined by an outer shoulder region and an inner shoulder region. The first welding electrode and the second welding electrode have a weld face diameter that is larger than the inside diameter and smaller than the outside diameter.

In accordance with another aspect of the disclosure, the method includes a coating formed of zinc.

In accordance with another aspect of the disclosure, the method includes a tip of the first concentric electrode and a tip of the second concentric electrode that includes a flat concentric surface.

In accordance with another aspect of the disclosure, the outside diameter is about 8 millimeters, and the inside diameter is about 5 millimeters.

In accordance with another aspect of the disclosure, the flat concentric surface has a thickness of about 3 millimeters, and the thickness extends axially from a cylindrical base.

In accordance with another aspect of the disclosure, the flat concentric surface has a ring width between the outside diameter and the inside diameter of about 1.5 millimeters.

In accordance with another aspect of the disclosure, the tip includes a rounded concentric surface.

In accordance with another aspect of the disclosure, the steel workpiece includes a third-generation advanced high strength steel (AHSS).

According to several aspects of the present disclosure, a combined electrode is provided. The combined electrode includes a welding electrode and a retractable concentric electrode movably coupled to and radially surrounding the welding electrode. The welding electrode has a weld face diameter that is larger than an inside diameter and smaller than an outside diameter. The welding electrode is configured to weld a steel workpiece stackup. The concentric electrode includes a cylindrical base and a tip disposed on the cylindrical base. The cylindrical base includes a conductive metal. The tip includes a concentric surface extending axially from the cylindrical base and defined by an outside shoulder having an outside diameter and an inside shoulder having an inside diameter. The tip is configured to provide an electrical current to the steel workpiece stackup and purge a coating from at least a portion of the steel workpiece stackup.

In accordance with another aspect of the disclosure, the combined electrode has an outside diameter of about 8 millimeters and an inside diameter of about 5 millimeters.

In accordance with another aspect of the disclosure, the combined electrode has a concentric surface that is flat and has a thickness of about 3 millimeters. The thickness extends axially from the cylindrical base, and a ring width between the outside diameter and the inside diameter is about 1.5 millimeters

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a side cross section view illustrating multiple steel workpieces and multiple concentric electrodes for removing a coating on the steel workpieces, in accordance with the present disclosure.

FIG. 2A is a perspective view illustrating the concentric electrode shown in FIG. 1, where the concentric electrode includes a cylindrical base and a tip, in accordance with the present disclosure.

FIG. 2B is a cross-section view illustrating the concentric electrode shown in FIG. 1, where the concentric electrode includes a cylindrical base and a tip, in accordance with the present disclosure.

FIG. 3 is a top view illustrating an exposed portion of the steel workpiece shown in FIG. 1 after a portion of the coating has been removed using the concentric electrode, in accordance with the present disclosure.

FIG. 4 is a side cross section view illustrating multiple steel workpieces and multiple welding electrodes for spot welding the steel workpieces after a portion of the coating has been removed using the concentric electrodes, in accordance with the present disclosure.

FIG. 5 is a side cross section view illustrating a combined electrode including a concentric electrode and a welding electrode, where the concentric electrode is extended to remove a portion of the coating on the steel workpiece, in accordance with the present disclosure.

FIG. 6 is a side cross section view illustrating the combined electrode shown in FIG. 5, where the concentric electrode is retracted and the welding electrode is in position to provide a spot weld, in accordance with the present disclosure.

FIG. 7 is a flowchart illustrating a method for two-step spot welding using the concentric electrode and the welding electrode shown in FIGS. 1-2B and 4, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

Liquid metal embrittlement (LME) cracking during spot welding is one reason for restricting coating Gen3 steels for vehicle body structure applications. Previous zinc coating removal methods, for example laser ablation, utilize off-line surface pretreatment, which may be time consuming and costly. The spot-welding process disclosed herein is an in-line process and reduces time and cost while significantly reducing LME cracking. The in-line zinc coating removal method disclosed herein enables Gen3 steel applications for vehicle body structure.

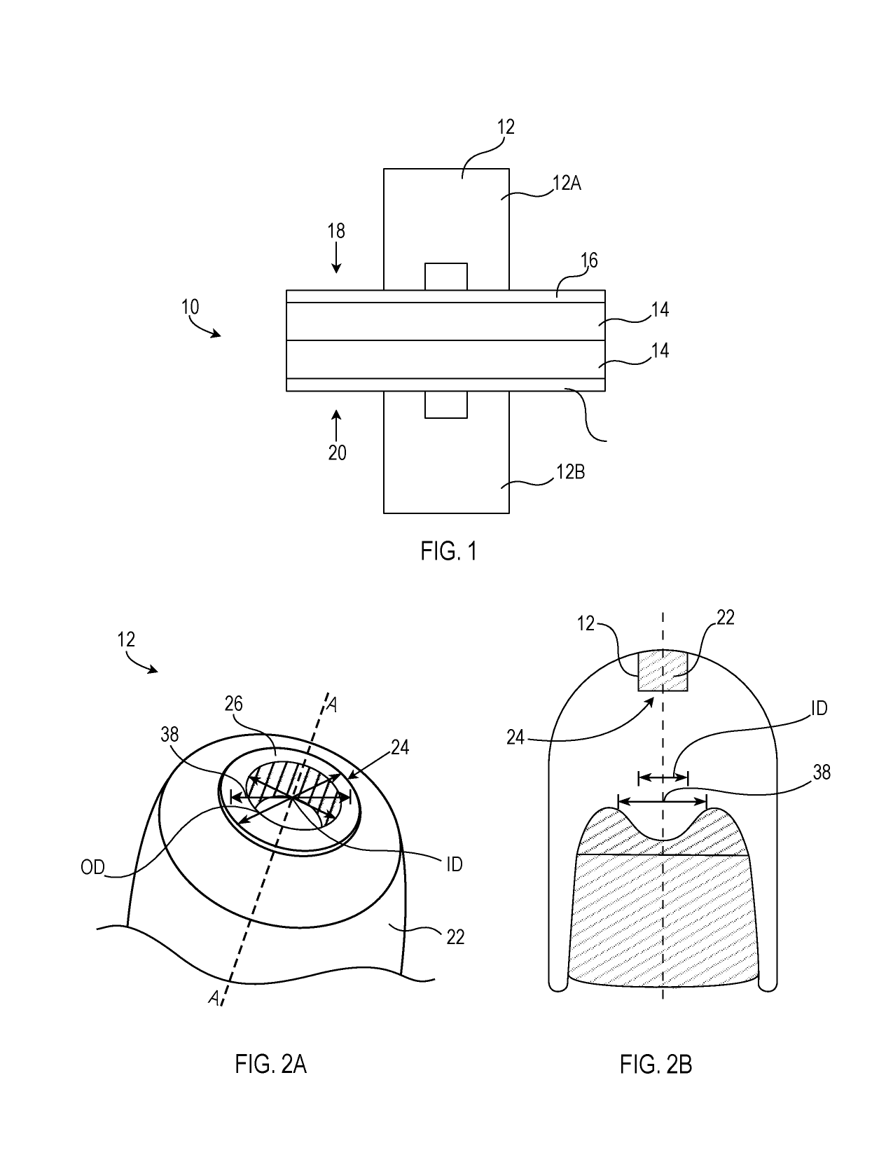

Referring to FIG.1, a cross-section view of a steel workpiece stackup 10 and a concentric electrode 12 is illustrated, in accordance with the present disclosure. The steel stackup 10 includes at least one workpiece 14 and a coating 16 disposed on the at least one workpiece 14. Even though FIG. 1 illustrates a coating 16 on one surface of the workpiece 14, the coating 16 may be disposed on both surfaces of the workpiece 14. The workpiece 14 may include at least one of steel or a steel alloy (e.g., third generation advanced high strength steel (AHSS)). It will be appreciated that each workpiece 14 may include different grades of steel or steel alloys with different thicknesses. Additionally, each coating 16 may be a different thickness. In one example, the steel workpiece 14 is further defined as a sheet metal component for a vehicle, such as a body panel. However, the steel workpiece 14 may be utilized with any component within a vehicle or in any suitable non-vehicular application.

In one example, the workpiece 14 includes iron, about 1.4 to about 2.0 weight percent aluminum, and about 0 to about 1.0 weight percent silicon. In another example, the workpiece 14 comprises about 1.5 to about 1.9 weight percent aluminum and about 0.2 to about 0.8 weight percent silicon. In yet another example, the workpiece 14 comprises about 1.6 to about 1.8 weight percent aluminum and about 0.4 to about 0.6 weight percent silicon. In this context, the term “about” is known to those skilled in the art. Alternatively, the term “about” may be read to mean plus or minus 0.15 weight percent.

The workpiece 14 may further comprise about 0.17 to about 0.35 weight percent carbon, about 2.0 to about 4.0 weight percent manganese, about 0 to about 0.01 weight percent sulfur, about 0 to about 0.2 weight percent copper, about 0 to about 0.008 weight percent nitrogen, about 0 to about 0.005 weight percent boron, and about 0 to about 0.04 weight percent phosphorus. The iron comprises the balance of the composition of the workpiece 14. The workpiece 14 may further comprise other elements which comprise less than 0.02 weight percent. The other elements are those not listed above but are disposed within the alloy substrate in the form of impurities. In this context, the term “about” is known to those skilled in the art. Alternatively, the term “about” may be read to mean plus or minus 0.15 weight percent.

The steel workpiece stackup 10 further comprises the coating 16, for example zinc. The coating 16 provides corrosion protection to the workpiece 14 wherein one or more of the elements (e.g., iron) are susceptible to oxidation. In one example, the coating 16 is applied to the workpiece 14 by galvanization (e.g., by immersion in molten zinc, electro-plating of zinc, etc.). However, the coating 16 may be applied in any suitable manner. Multiple steel workpieces 14 are assembled adjacent to one another into a workpiece stackup 10, as shown in FIG. 1. It will be appreciated that even though only two workpieces 14 are illustrated in FIG. 1, additional workpieces may be added to the stackup 10 (e.g., three workpieces, four work pieces, and so forth). The steel workpieces 14 may then be spot welded together. When the zinc-coated steel workpieces 14 are spot welded, the zinc coating 16 becomes liquified and penetrates the steel grain boundary. The zinc coating 16 facilitates a phenomenon known in the art as liquid metal embrittlement, in which stack-up 10 experiences drastic loss in tensile ductility and/or undergo brittle fracture due to the penetrating zinc, which is undesirable.

Still referring to FIG. 1, the concentric electrode 12 can be positioned adjacent to the steel workpiece stackup 10 to purge a portion of the coating 16 from the steel workpiece. In the example shown in FIG. 1, a first concentric electrode 12A is disposed on a first side 18 of the steel workpiece stackup 10, and a second concentric electrode 12B is disposed on a second side 20 of the steel workpiece stackup 10.

FIGS. 2A and 2B illustrate a perspective view and a cross-section view, respectively, of the concentric electrode 12. In this example, the concentric electrode 12 includes a cylindrical base 22. The cylindrical base 22 extends axially along an axis of rotation A. The cylindrical base 22 includes a conductive metal, for example copper.

Referring still to FIGS. 2A and 2B, the concentric electrode 12 includes a tip 24. The tip 24 is disposed on the cylindrical base 22 and is configured to provide an electrical current to the steel workpiece(s) 14 to purge the coating 16 from a portion of the steel workpiece(s) 14. The tip 24 is defined by an outside diameter OD and an inside diameter ID and has a concentric surface 26 or face. As illustrated in the example depicted in FIGS. 2A and 2B, the concentric surface 26 may have a flat surface (e.g., planar). In other examples, the concentric surface 26 may be domed and/or rounded. It should be appreciated that the concentric surface 26 may be configured and/or shaped in a variety of other ways.

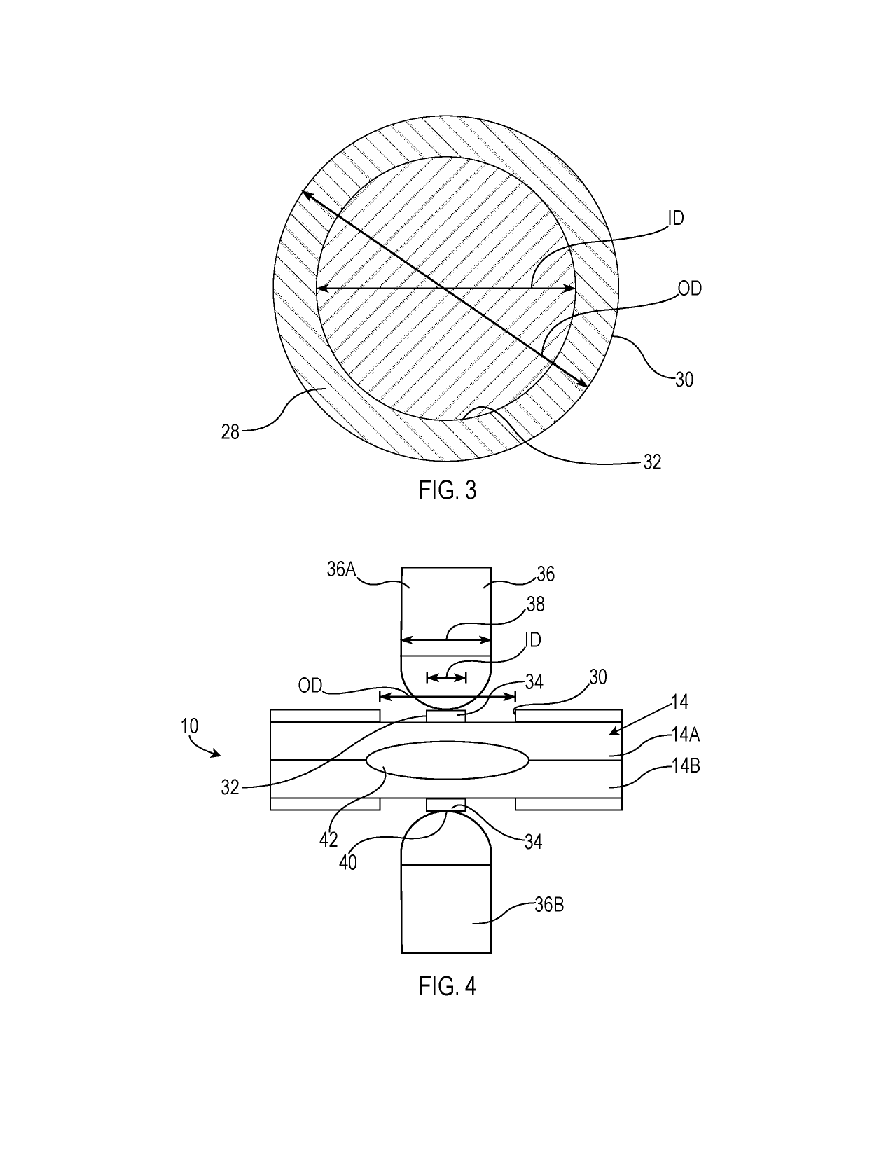

FIG. 3 illustrates a top view of an exposed portion 28 of the steel workpiece 14 after a portion of the coating 16 has been removed using the concentric electrode 12. In this example, the exposed portion 28 is circular or concentric. The exposed portion 28 is defined by an outside diameter OD and an inside diameter ID. The outside diameter OD further defines an outer shoulder 30 of the coating 16, and the inside diameter ID further defines an inner shoulder 32 of the coating 16. The inner shoulder 32 defines a central portion 34 of the coating 16, which remains after coating 16 removal by the concentric electrode 12. In the example shown in FIG. 3, the exposed portion 28 has an inside diameter ID of about 5.00 millimeters (mm) and an outside diameter OD of about 8.00 mm. It should be appreciated that the exposed portion 28 may include a variety of outside diameters (e.g., 7.00 mm, 7.50 mm, 8.50 mm, and so forth) and may include a variety of inside diameters (e.g., 4.00 mm, 4.50 mm, 5.50 mm, and so forth). In this context, the term “about” is known to those skilled in the art. Alternatively, the term “about” may be read to mean plus or minus 0.15 millimeters. Additionally, a depth or thickness of the removed coating 16 is more than 0 micrometers (µm) and less than 200 µm. In one example, the coating 16 is about 50 µm. It should be appreciated that the exposed portion 28 may include a variety of depths or thicknesses (e.g., 25 µm, 75 µm, 100 µm, 185 µm, and so forth). In this context, the term “about” is known to those skilled in the art. Alternatively, the term “about” may be read to mean plus or minus 5 µm.

Referring to FIG. 4, a welding electrode 36, for example coupled to a welding robot, is then placed in a position to weld to the steel workpiece(s) 14. The welding electrode 36 can include, for example, a copper spot welding electrode. The welding electrode 36 has a weld face 38, which has a diameter that is larger than an inside diameter ID and smaller than the outside diameter OD. In the example illustrated in FIG. 4, a first workpiece 14A and a second workpiece 14B are positioned together, and a first welding electrode 36A is disposed proximate to and contacts the first workpiece 14A while a second welding electrode 36B is disposed proximate to and contacts the second workpiece 14B. A welding current passes from the first welding electrode 36A and the second welding electrode 36B and through the first workpiece 14A and the second workpiece 14B generating resistive heat at the welding point 40 to create molten metal. The molten metal then cools and forms a weld nugget 42, which joins the first workpiece 14A and the second workpiece 14B.

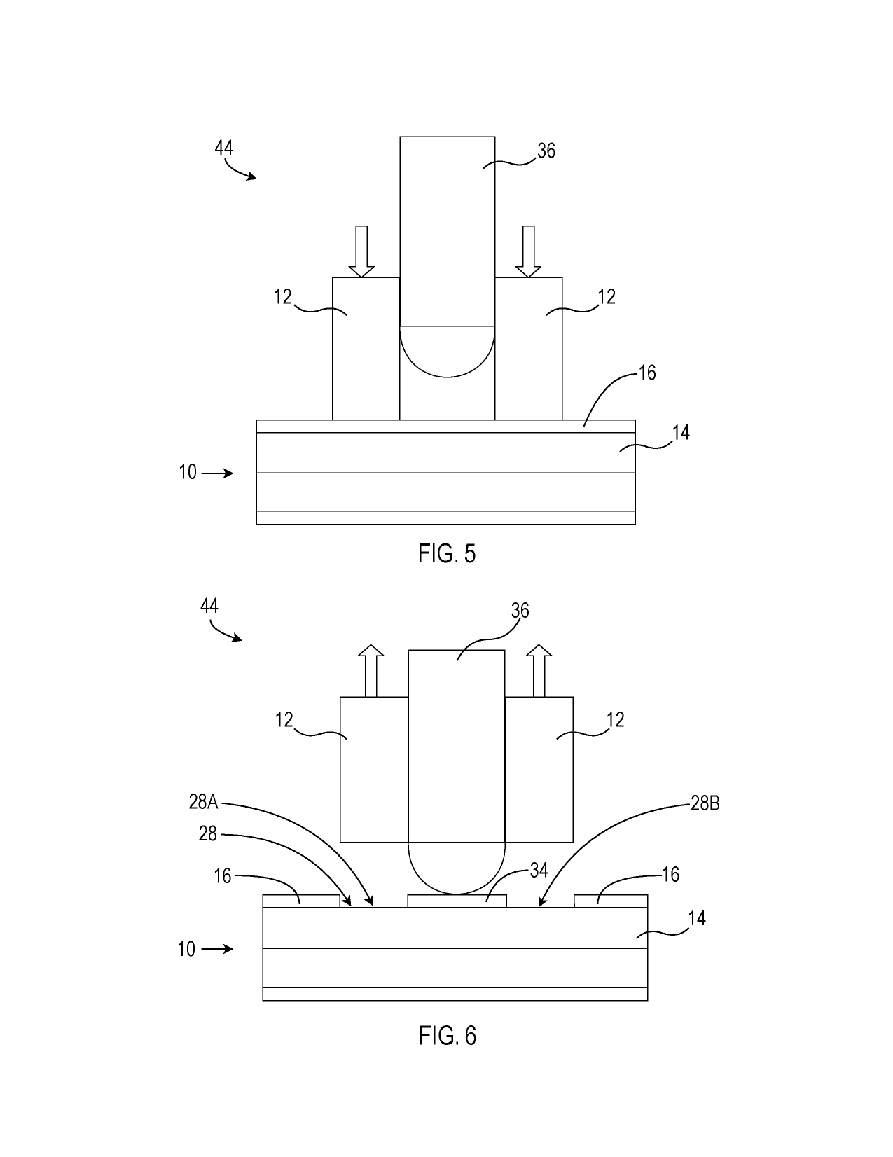

FIGS. 5 and 6 illustrate a cross-section view of a combined electrode 44 disposed on one side of the workpiece stackup 10. However, in practice, a combined electrode 44 is disposed on both sides of the stackup 10 (e.g., a first combined electrode 44 is disposed on a first side of the stackup 10, and a second combined electrode is disposed on a second side of the stackup 10 opposite the first side). The combined electrode 44 includes the concentric electrode 12 and the welding electrode 36 in a combined configuration. The welding electrode 36 can be cylindrical and configured to contact a portion of the coating 16. The concentric electrode 12 may be concentric and retractably surrounds the welding electrode 36.

As shown in FIG. 5, the combined electrode 44 is placed proximate to the workpiece 14 with the concentric electrode 12 extended and contacting the workpiece 14. The concentric electrode 12 is then used to remove a portion of the coating 16 to create the exposed portion 28 as described above.

After the exposed portion 28 is formed, and as shown in FIG. 6, the concentric electrode 12 is retracted, and the welding electrode 36 is positioned to contact the workpiece 14 for providing a spot weld to the workpiece stackup 10. Although only one combined electrode 44 is depicted in FIGS. 5 and 6, multiple combined electrodes 44 are used to create a spot weld. The concentric electrode 12 may be extended and/or retracted using, for example, an actuator and/or motor.

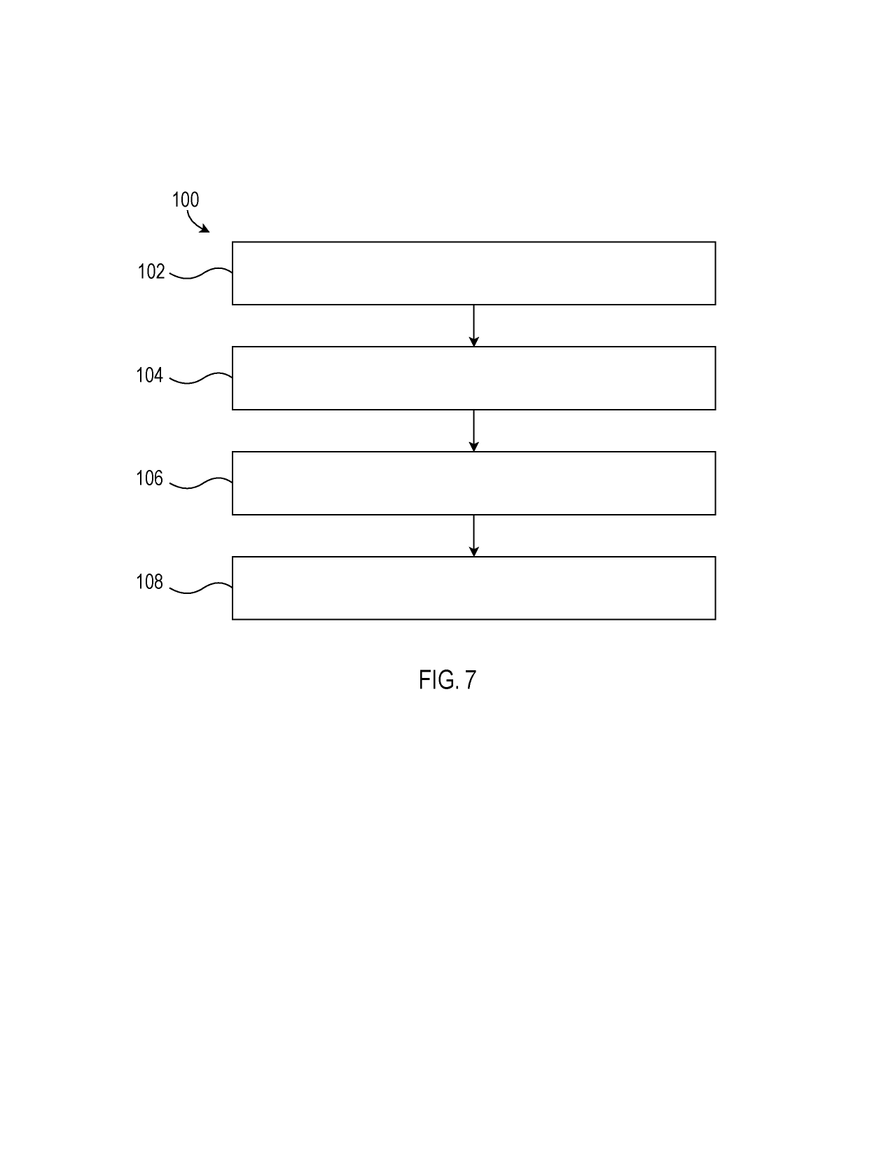

With reference to FIG. 7, a method 100 for two-step spot welding the workpiece stackup 10 is presented, in accordance with the present disclosure. The method starts at block 102.

Block 102 depicts providing a workpiece stackup 10. The workpiece stackup 10 includes a first steel workpiece 14 and a second steel workpiece 14. The first steel workpiece 14 and the second steel workpiece 14 each include a coating 16, which can be zinc as described above. The method then moves to block 104.

Block 104 depicts contacting a first concentric electrode 12A to the first steel workpiece 14A and contacting a second concentric electrode 12B to the second steel workpiece 14B. In an example, the first concentric electrode 12A is coupled to and controlled by a welding robot, and the second concentric electrode 12B is coupled to and controlled by a second welding robot. The method then moves to block 106.

Block 106 depicts purging a coating from the first steel workpiece 14A to form a first local exposed portion 28A and from the second steel workpiece 14B to form a second local exposed portion 28B. Purging the coating 16 can include passing an electric current between the first concentric electrode 12A and the second concentric electrode 12B and through the workpiece stackup 10. The first local exposed portion 28A and the second local exposed portion 28B are shaped in the form of a concentric circle or ring that is defined by the outside diameter OD and the inside diameter ID and are defined by an outer shoulder 30 and an inner shoulder 32. The method then moves to block 108.

Block 108 depicts spot welding the first steel workpiece 14A and the second steel workpiece 14B using a first welding electrode 36A and a second welding electrode 36B. Spot welding includes using the first welding electrode 36A and the second welding electrode 36B. The first welding electrode 36A and the second welding electrode 36B each have a weld face diameter that is larger than the inside diameter ID and smaller than the outside diameter OD.

The steel workpiece and spot-welding method of the present disclosure is advantageous and beneficial over the prior art. The concentric electrode 12 and method for removing the coating 16 including zinc is an in-line process and reduces time and cost while significantly reducing LME cracking. The in-line zinc coating removal method disclosed herein enables Gen3 steel applications to be utilized for vehicle body structure components.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A concentric electrode, comprising:
a cylindrical base extending axially along an axis of rotation, the cylindrical base including a conductive metal; and
a tip disposed on the cylindrical base, the tip including a concentric surface extending axially from the cylindrical base and defined by an outer shoulder having an outside diameter and an inner shoulder having an inside diameter,
wherein the tip is configured to provide an electrical current to a steel workpiece and purge a coating from at least a portion of the steel workpiece.

2. The concentric electrode of claim 1, wherein the tip includes a flat concentric surface.

3. The concentric electrode of claim 2, wherein the outside diameter is about 8 millimeters, and the inside diameter is about 5 millimeters.

4. The concentric electrode of claim 2, wherein the flat concentric surface has a thickness of about 3 millimeters, wherein the thickness extends axially from the cylindrical base.

5. The concentric electrode of claim 2, wherein the flat concentric surface has a ring width between the outside diameter and the inside diameter of about 1.5 millimeters.

6. The concentric electrode of claim 1, wherein the tip includes a rounded concentric surface.

7. The concentric electrode of claim 1, wherein the steel workpiece includes a third-generation advanced high strength steel (AHSS).

8. The concentric electrode of claim 1, wherein the coating is zinc.

9. The concentric electrode of claim 1, wherein the concentric electrode is coupled to a welding robot.

10. A method of two-step spot welding, comprising:
providing a workpiece stackup including a first steel workpiece and a second steel workpiece, wherein the first steel workpiece and the second steel workpiece include a coating;
contacting a first concentric electrode to the first steel workpiece and contacting a second concentric electrode to the second steel workpiece, wherein the first concentric electrode and the second concentric electrode each have an outside diameter, an inside diameter, and a tip;
purging a coating from the first steel workpiece to form a first local exposed portion and from the second steel workpiece to form a second local exposed portion by passing an electric current between the first concentric electrode and the second concentric electrode and through the workpiece stackup, wherein the locally exposed portions are shaped in the form of a concentric circle having the outside diameter and the inside diameter and are defined by an outer shoulder region and an inner shoulder region; and
spot welding the first steel workpiece and the second steel workpiece using a first welding electrode and a second welding electrode, respectively, wherein the first welding electrode and the second welding electrode have a weld face diameter that is larger than the inside diameter and smaller than the outside diameter.

11. The method of two-step spot welding of claim 10, wherein the coating includes zinc.

12. The method of two-step spot welding of claim 10, wherein a tip of the first concentric electrode and a tip of the second concentric electrode include a flat concentric surface.

13. The method of two-step spot welding of claim 12, wherein the outside diameter is about 8 millimeters, and the inside diameter is about 5 millimeters.

14. The method of two-step spot welding of claim 12, wherein the flat concentric surface has a thickness of about 3 millimeters, wherein the thickness extends axially from a cylindrical base.

15. The method of two-step spot welding of claim 12, wherein the flat concentric surface has a ring width between the outside diameter and the inside diameter of about 1.5 millimeters.

16. The method of two-step spot welding of claim 10, wherein the tip includes a rounded concentric surface.

17. The method of two-step spot welding of claim 10, wherein the steel workpiece includes a third-generation advanced high strength steel (AHSS).

18. A combined electrode, comprising:
a welding electrode having a weld face diameter that is larger than an inside diameter and smaller than an outside diameter, wherein the welding electrode is configured to weld a steel workpiece stackup; and
a retractable concentric electrode movably coupled to and radially surrounding the welding electrode, the concentric electrode including
a cylindrical base extending axially along an axis of rotation, the cylindrical base including a conductive metal;
a tip disposed on the cylindrical base, the tip including a concentric surface extending axially from the cylindrical base and defined by an outside shoulder having an outside diameter and an inside shoulder having an inside diameter; and
wherein the tip is configured to provide an electrical current to the steel workpiece stackup and purge a coating from at least a portion of the steel workpiece stackup.

19. The combined electrode of claim 18, wherein the outside diameter is about 8 millimeters, and the inside diameter is about 5 millimeters.

20. The combined electrode of claim 18, wherein the concentric surface is flat and has a thickness of about 3 millimeters, wherein the thickness extends axially from the cylindrical base and a ring width between the outside diameter and the inside diameter of about 1.5 millimeters.
